(19) United States
(12) Patent Application Publication
(10) Pub. No.: US 2025/0142296 A1
(43) Pub. Date: May 1, 2025

(54) SERVICE MIDDLEWARE FOR MOBILE USER OBJECT SYSTEM (MUOS) GROUP DATA DISSEMINATION

(71) Applicant: Booz Allen Hamilton Inc., McLean, VA (US)

(72) Inventors: Jeffrey Palumbo, McLean, VA (US); Dake Amenyah, McLean, VA (US)

(73) Assignee: Booz Allen Hamilton Inc., McLean, VA (US)

(21) Appl. No.: 18/930,602

(22) Filed: Oct. 29, 2024

Related U.S. Application Data
(60) Provisional application No. 63/546,596, filed on Oct. 31, 2023.

(51) Int. Cl. H04W 4/08; H04L 41/0213; H04W 74/0816

(52) U.S. Cl. CPC H04W 4/08; H04L 41/0213; H04W 74/0816

(57) ABSTRACT

Methods performed by a host platform operable in a Mobile User Objective System (MUOS) network are provided herein. A method according to some examples may include monitoring for outgoing data from a client, parsing the outgoing data to determine a priority level associated with the outgoing data, and queuing the outgoing data based on the priority level. Some methods may include monitoring for Secure Network Management Protocol (SNMP) traps to determine a floor status associated with an over-the-air interface. In some methods, if an SNMP trap is received indicating that the floor status associated with the over-the air interface is available, the queued outgoing data may be forwarded to a terminal for transmission via the over-the-air interface.

### CROSS REFERENCE TO RELATED APPLICATIONS

This application claims the benefit of U.S. Provisional Application No. 63/546,596, filed Oct. 31, 2023, which is incorporated by reference as if fully set forth.

### BACKGROUND OF THE INVENTION

The Mobile User Object System (MUOS) is a satellite-based communication system that was developed by Joint Department of Defense (DoD) services (Navy, Air Force and Army). MUOS provides global coverage for terminals to exchange voice and Internet Protocol (IP) data in tactical environments. It provides three methods, referred to as services, to pass voice and/or data between the terminals. Each service is unique in operation and capabilities.

Once such service is referred to as “group service.” This service establishes a “party bus”-like channel for all members to communicate. The MUOS Group service may allow terminals to pass voice and host data on the same channel. However, the group service may have limited capabilities (e.g., data rate, which may be limited to 9600 bits per second) and may be half-duplexed, meaning only one terminal may send host data at a time and all other terminals are automatically put into receive-only mode.

### SUMMARY OF THE INVENTION

Methods performed by a host platform operable in a Mobile User Objective System (MUOS) network are provided herein. A method according to some examples may include monitoring for outgoing data from a client, parsing the outgoing data to determine a priority level associated with the outgoing data, and queuing the outgoing data based on the priority level. Some methods may include monitoring for Secure Network Management Protocol (SNMP) traps to determine a floor status associated with an over-the-air interface. In some methods, if an SNMP trap is received indicating that the floor status associated with the over-the air interface is ‘available, the queued outgoing data may be forwarded to a terminal for attempted transmission via the over-the-air interface.

### BRIEF DESCRIPTION OF THE DRAWINGS

FIG. 1 is a top-level architecture diagram illustrating connections between logical nodes in a MUOS network;

FIG. 2 is a system diagram illustrating an example of hardware implementation of a host platform;

FIG. 3 is a system diagram illustrating an example configuration of a terminal configured to operate within the MUOS network;

FIG. 4 is a state diagram illustrating the behavior of a host platform and a terminal operating in a MUOS system without the benefit of a middleware or a coordinated multi-user channel access protocol;

FIG. 5 is a diagram illustrating traffic flows between a host platform and a terminal;

FIG. 6 is a software architecture diagram illustrating logical interfaces of a middleware operating on a host platform;

FIG. 7 is a diagram illustrating fields of a packet header as may be included in a payload;

FIG. 8 is a diagram illustrating fields of a trailer as may be included in a payload;

FIG. 9 is a state diagram illustrating various modes of operation stipulated by a middleware; and

FIG. 10 is a flow chart illustrating an exemplary method as may be performed by a host platform operable in a MUOS network described herein.

### DETAILED DESCRIPTION OF EXAMPLES

### Top-Level Architecture

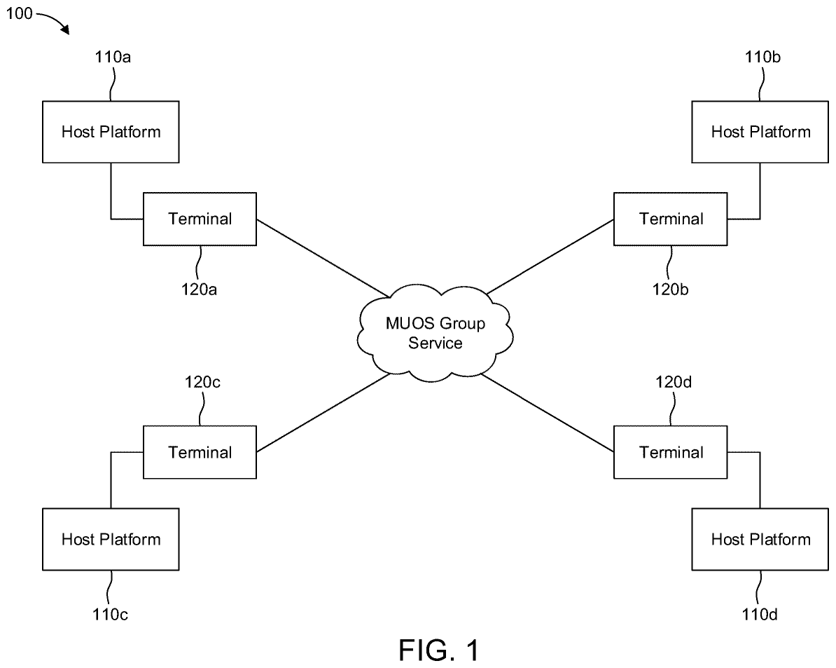

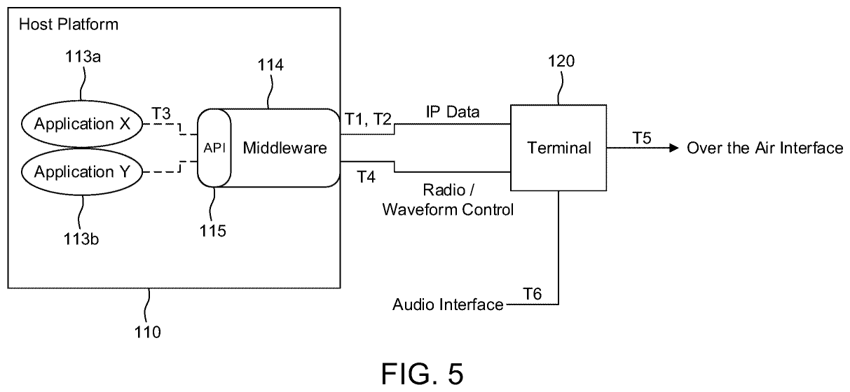

FIG. 1 is a top-level architecture diagram illustrating connections between logical nodes in a MUOS network. In the example depicted in FIG. 1, the network 100 includes four terminals 120a, 120b, 120c, and 120d, but those of ordinary skill in the art will appreciate that a MUOS group service may support greater or fewer numbers of terminals. Each of the terminals 120a, 120b, 120c, and 120d depicted in FIG. 1 further interfaces with a host platform 110a, 110b, 110c, or 110d via at least one internet protocol (IP)-based connection, which carries packetized data between the terminal and host platform. The IP-based connection may be implemented through any number of different types of interfaces as are further described below with respect to FIG. 5. Each of the terminals 120a, 120b, 120c, and 120d as illustrated in FIG. 1 are configured to communicate voice and IP data with one or more other terminals using the MUOS group service.

Though not depicted in the illustration of FIG. 1, logical data flows distributed via the MUOS group service may interact with other nodes (e.g., physical and/or logical nodes). For example, terminals may communicate data flows with nodes of a space and/or ground segment, which may include one or more satellites, ground stations or other ground-based infrastructure, or security infrastructure. Satellite vehicles (SVs) of a MUOS network may serve as the primary communication relays in the space segment and facilitate communication between terminals on the ground, in the air, and ground infrastructure through connections with ground station infrastructure. A terminal sends its signals to an SV, which redirects and beam-down the signals to the necessary ground infrastructure that can route the traffic to the intended recipient terminal. In some cases, signals from one terminal may be redirected through multiple SVs and/or ground stations to reach the intended recipient terminal. For example, an SV may capture signals from a transmitting terminal and redirect these signals to a ground station, which can forward the data in those signals to another ground station that will transmit the data to another SV which will then forward the data to a terminal within its coverage area, thus promoting global coverage and connectivity. In the ground segment, ground stations may handle various tasks such as satellite management, signal routing, and integration with other communication networks. In some cases, a ground station may act as gateway, linking the MUOS network with conventional communication networks, providing users with a broader range of connectivity.

### Host Platform

A description of the host platform (i.e., the host platform 110) is provided herein. The term “host platform” as used herein may refer to a logical implementation of communication and/or processing capabilities for performing steps or procedures described herein. For example, a host platform may refer to software (e.g., an application, a plug-in, an extension, or an add-on) executed by a computing device or may refer to a physical device implementing means for carrying out functionality described herein. In some examples, the term “host platform” may be used to refer to a physical implementation, i.e., hardware responsible for executing software to carry out functionalities described herein. In a hardware implementation, the host platform may be integrated within other physical nodes of the MUOS network, such as the terminal. Alternatively, the host platform may be implemented in hardware separate from other nodes of the MUOS networks. For instance, the host platform may refer to software executed by a computer processing unit (CPU) that is connected with one or more interfaces (e.g., wired and/or wireless interfaces). Examples of devices at which the host platform software may be executed, or which may be referred to as host devices themselves, may include: a handheld device, a mobile phone, a tablet computer, a laptop computer or other computing device, a network server, a server blade, radio infrastructure equipment such as a base station, access point, a modem, or specialized hardware for computing and/or communication in military contexts, such as devices of the Mounted Family of Computing Systems (MFoCS), Command Post Computing Environment (CPCE), Advanced Field Artillery Tactical Data System (AFATDS), and dismount soldier end-user devices.

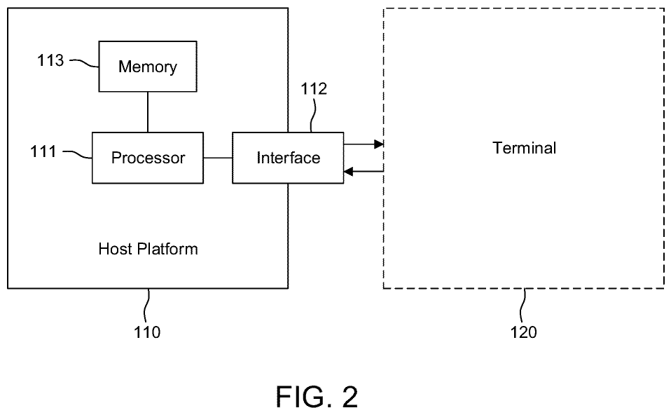

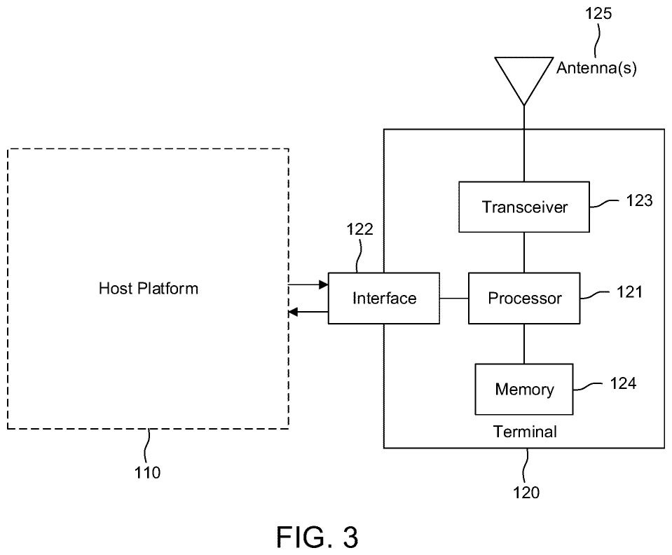

FIG. 2 is a system diagram illustrating an example of hardware implementation a host platform. As shown in FIG. 2, a hardware implementation of the host platform 110 includes at least one processor 111, a memory 113, and at least one interface 112. The host platform 110 illustrated in FIG. 2 is configured to communicate with the terminal 120 shown in FIG. 3 in a manner similar to the host platforms 110a, 110b, 110c, and 110d of the MUOS network 100 shown in FIG. 1. Although the illustrated implementation of the host platform 110 is envisioned to communicate with the terminal 120 via ethernet (Eth), Universal Serial Bus (USB), or serial interfaces, other specific examples of different types of physical interfaces that may in concept be used between the host platform and the terminal include: Serial Communication (RS-232), High-Definition Multimedia Interface (HDMI), FireWire (IEEE 1394), PCI Express (PCIe), wireless interfaces utilizing protocols such as Bluetooth, Wi-Fi, or cellular protocols such as GSM, CDMA, Long-Term Evolution (LTE), or New Radio (NR), wired interfaces such as Fiber Optic, Small Computer System Interface (SCSI), InfiniBand, Controller Area Network (CAN bus), Integrated Services Digital Network (ISDN), T1/E1, or any other interface capable of support exchanges of IP data and/or control signaling.

### Terminal

A description of the terminals 120a, 120b, 120c, and 120d as illustrated in FIG. 1 is provided herein. A terminal may be referred to interchangeably herein as a MUOS terminal, a receiving terminal, a transmitting terminal, a wireless terminal, a wireless transmit/receive unit (WTRU), a user equipment (UE), a station (STA), a handset, a radio, a transmitter, a transmit device, a receiver, or a receive device. A terminal as referred to herein, such as terminals 120a, 120b, 120c, and/or 120d may be, for example, a portable (e.g., handheld) radio, a vehicle mounted radio, stationary radio infrastructure equipment, a modem, a mobile phone, an radio frequency (RF) front end, a computer or computing device coupled with hardware providing transmit or receive capabilities, a software defined radio (SDR), or any other type of radio transmitter/receiver/transceiver.

FIG. 3 is a system diagram illustrating an example configuration of a terminal configured to operate within the MUOS network, consistent with the terminals 120a, 120b, 120c, and 120d illustrated in FIG. 1.

A terminal 120 as illustrated in the example of FIG. 3 includes at least one processor 121, at least one transceiver 123 (or alternatively, a transmitter and a receiver implemented in either an integral or discrete manner in hardware), a memory 124, and at least one antenna 125. The terminal 120 as shown in FIG. 3 is configured to transmit and receive signals over a wireless medium via the transceiver 123 and antenna(s) 125. Additionally, the processor 121 is configured to separately communicate (i.e., send and/or receive) traffic with other nodes in the MUOS network via the interface 122, which is described in further detail in paragraphs below. In the example shown in FIG. 1, the terminal 120 communicates with a host platform 110, further described with respect to FIG. 3 in paragraphs below. The terminal 120 may also include additional elements further described in subsequent paragraphs. The terminal 120 may include any sub-combination of such elements.

A processor as described herein (such as the processor 111 of the host platform 110, introduced and described in the context of FIG. 2, or the processor 121 of the terminal 120 shown in FIG. 3) may be a general purpose processor or a special-purpose processor. In some examples, the processor may act as the central processing unit for terminal operations. The processor manages and coordinates all tasks, ensuring efficient communication, signal processing, and user command execution. The processor 121 shown in FIG. 2 is coupled with the memory 124, with the transceiver 123, and with the one or more antennas 125.

A processor as described herein (such as the processor 111 of the host platform 110, introduced and described in the context of FIG. 2, or the processor 121 of the terminal 120 shown in FIG. 3), which may include one or multiple processors, may be implemented via any type of circuit including integrated circuits, application-specific integrated circuits (ASIC) and/or field programmable gate arrays (FPGA). The processor may be created using semiconductor(s), transistors, with components like electronic integrated circuits (IC), and more. These processors, either individually or in conjunction, may carry out the functions and/or steps detailed in this document. The processor is configured to interface with one or more memory modules, which may include internal and/or external storage spaces for data, executable instructions, and other content communicated via or necessary for communication within the MUOS network. The processor is configured to execute software programs stored on a computer-readable medium, which may define steps according to one or more methods delineated herein. For example, a processor as described herein and illustrated in FIG. 3 by processor 111 of the host platform 110 or the processor 121 of the terminal 120 may be configured to execute middleware that provides functionality as will be described in further detail in paragraphs below.

A memory (such as the memory 113 of the host platform 110 described in FIG. 2, or the memory 124 of the terminal 120 described in FIG. 3) may be any tangible medium, non-volatile medium, volatile medium, transmission media, or computer-readable storage medium that provides functionality for storing data and/or program code, or instructions used for operation of the MUOS system and/or the processor. The data, program code, and/or instructions may be in the form of algorithms, or program logic that cause the processor and/or other components of the MUOS system of FIG. 1 to execute any of the functions disclosed herein. The memory may, for example, facilitate real-time data processing, buffering of incoming and outgoing signals, and storage of necessary encryption keys and user configurations. Additionally, it holds logs of communication sessions and can store data temporarily during transmissions. The memory may be integral with the controller or may be stand-alone memory, or a combination of the two. The memory may include removable and/or non-removable memory components. Examples of different types of memory may include random-access memory (RAM), read-only memory (ROM), flash memory (e.g., secure digital (SD) memory), solid-state drive (SSD) memory, magnetic memory, optical memory, universal serial bus (USB) memory devices, hard disk memory, external memory, to list a few examples.

The transceiver 123 of the terminal 120 is a bidirectional module responsible for transmitting and receiving signals to and from nodes within the MUOS system. It interfaces with both the processor, which provides data and command signals, and the antenna system, which facilitates over-the-air communication. The processor 121 and the transceiver 123 may, for example, be configured to utilize one or more modulation schemes or over-the-air communication such as code division multiple access (CDMA), or wideband CDMA (WCDMA), though those of ordinary skill in the art will appreciate that other types of modulation schemes may be utilized and remain consistent with examples described herein.

One or more antennas 125 are connected to the transceiver 122. The antenna 125 may be configured to operate in the Ultra-High-Frequency (UHF) band, optimizing communication with the MUOS satellite system. The antenna 125 may be part of an antenna system that includes fixed or steerable antennas, which may operate to ensure optimal signal reception and transmission, regardless of the terminal's orientation or location. The antenna 125 may include, for example, omnidirectional antennas, directional antennas, and/or antenna panels.

Before transmission, voice signals (which may be analog in nature) may be converted into digital signals using an Analog-to-Digital Converter (ADC), as digital signals may be more suitable for processing and transmission in a digital communication system. The terminal may process raw voice and/or raw data signals through encoding and compression to add redundancy to the data, for error detection and correction by a receiving terminal, while reducing the size of the data for efficiency. The processor may modulate the digital signals using a specific waveform suitable for communication in the MUOS network. This may involve adjusting properties (e.g., amplitude, frequency, or phase) of a carrier wave according to the data being sent. This prepares the data for transmission over the radio frequency (RF) medium. Once modulated, the signals may be passed through a power amplifier, boosting their strength for long-distance transmission. Amplified signals may then be transmitted via the terminal's antenna, radiating them as electromagnetic waves towards the satellite, depending on the communication architecture.

A receiving terminal may perform the above-referenced steps in a reversed sequence. For example, the receiving terminal may capture the RF signals using its antenna(s), demodulate the captured signals to retrieve the digital data, and then decode and decompress the digital data. In the case of voice data, the data may be converted back into analog form using a Digital-to-Analog Converter (DAC) for playback.

### Collision Avoidance Strategy

Methods proposed herein may provide means for applications to leverage the MUOS group service without requiring any modifications or even awareness of the fact that the MUOS group service is being used. This may be accomplished using software (which may be referred to herein as a middleware) that receives the data to be sent to members of the MUOS group and provides a prioritized queuing scheme to hold data until it is sent. Additionally, the middleware may monitor the terminal for channel availability to avoid collisions, prioritizes traffic to be sent, prevents undesirable channel conditions, provide voice override protection, message acknowledgement, and package data to be sent in an efficient manner to maximize network capacity. When an application sends data to the middleware, the middleware may handle all the interactions with the terminal to include packaging and sending the data to the terminal for transmission and receiving MUOS delivered data and providing it to receiving applications for their use. A middleware referred to herein may be executed by a computer, a processor, processing device, or a circuit (e.g., a general purpose or specialized circuit), for example, illustrated by the processor 111 of the host platform 110 in FIG. 3.

It should be noted that an existing MUOS system may not have any built-in mechanisms to support coordinated multi-user channel access for this group service. In other words, a terminal's ability to send voice or data from a host may be a matter of which terminal accesses the channel first. In some methods for collision avoidance, when a terminal ceases to send voice/host data for a specific amount of time (e.g., 1 second), the terminal may be blocked from being able to transmit again for a given blocked period (e.g., 7 seconds). At that point, any other terminal may contend for the channel and send voice/data. Without the functionality for preventing a connected host platform from continuously sending data to its terminal, without (for example) at least a 1-second delay between packets, the terminal may never release the shared group channel, effectively blocking all other terminals from sending voice/data and resulting in a condition referred to as a “hot mic.” In addition, without any functionality supporting coordinated multi-user channel access, when a terminal is in receive-only mode, or when it is in the 7-second blocked period, host application data that is sent to the terminal may be simply dropped without any queuing for resend by the terminal, and without a notification to the application attempting to send data. This behavior may require applications to be aware of these MUOS-specific behaviors and to address them on their own.

In some examples, the MUOS group service may provide a voice override capability that enables any terminal to be able to interrupt an ongoing data transmission for the purpose of passing voice. In such cases, without the functionality of the middleware described herein, the interrupted transmitting terminal may receive no notification that an override has occurred, leaving part of all its data unsent and dropped. Current message-based applications typically deployed in broadcast, tactical networks may not be equipped to address this unique channel access scheme, resulting in their inability to leverage the MUOS group service.

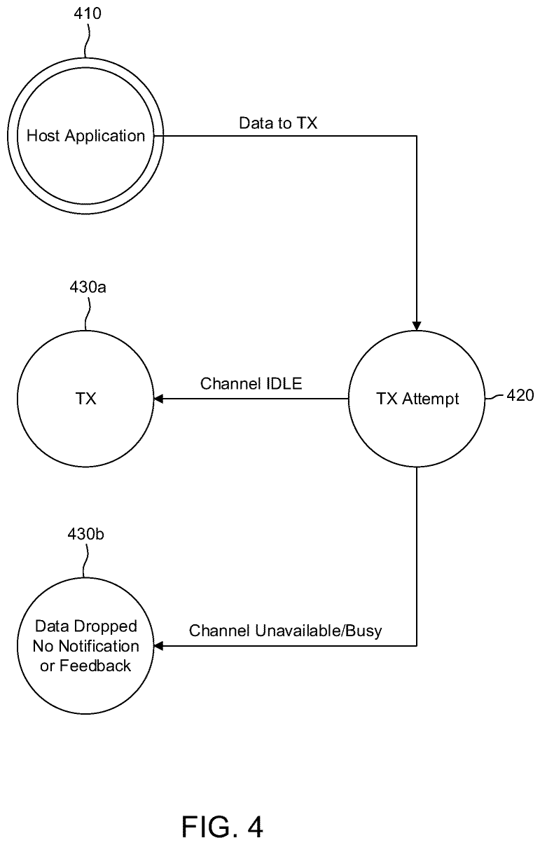

FIG. 4 is a state diagram illustrating the behavior of the host platform 110 and a terminal 120 operating in a MUOS system without the benefit of the middleware or without a coordinated multi-user channel access scheme as described in paragraphs above. As shown in FIG. 4 at 410, the host platform 110 runs one or more host applications that generate data (e.g., internet protocol (IP) packets) destined for transmission to MUOS group members via the terminal 120. Upon determining that data is queued for transmission, at 420, the host platform 110 initiates a transmission (TX) attempt regardless of the current channel conditions or availability. If the channel is idle (i.e., unoccupied or available for access), the transmission is carried out (i.e., without interruption or interference) on the idle channel, as shown at 430a. If the channel is unavailable or busy, as shown at 430b, the TX attempt may be carried out, but the transmission may be interrupted or interfered with, or group members to which the transmission is sent may otherwise fail to receive or decode the transmission. If the channel is unavailable or busy, the TX attempt may also cause interference with an ongoing transmission.

If the channel is unavailable or busy, data carried by the transmission may be dropped. Because one or more of the group members may fail to receive or decode the transmission, the host platform 110 may fail to receive any notification, feedback, or other indication that the data was dropped. Without any notification or feedback, the host platform may not have any mechanism for retransmission of the dropped data.

### Software Architecture

As described substantially in paragraphs above, the host platform 110 operating within the MUOS network is configured to interface with the terminal 120 via at least one internet protocol (IP)-based connection. The interfaces 112 and 122 may permit the exchange of IP data between the host platform 110 and the terminal 120, including incoming IP data received over-the-air by the terminal 120 and/or outgoing IP data to be transmitted by the terminal 120 via the radio interface. The interfaces 112 and 122 also enable the host platform to assess the status of the radio channel and/or waveform being transmitted or received by the terminal 120.

FIG. 5 is a diagram illustrating traffic flows exchanged between the host platform 110 and the terminal 120 operating in a MUOS system using middleware or a coordinated multi-user channel access scheme. As shown, the host platform 110 is configured to run one or more applications (e.g., applications 113a and/or 113b as shown in FIG. 5), each of which interface with a middleware 114. The exchange of traffic T3 between applications 113a and/or 113b and the middleware 114 is facilitated by an application programming interface (API) 115. The API 115 may enable certain functionality, such as push or pull requests, or triggering of operations carried out by the applications 113a and/or 113b or by the middleware 114. The API 115 may be configured with standardized input and output parameters to ensure the applications 113a and/or 113b and middleware 114 are able to communicate.

As is further shown in FIG. 5, the host platform 110 and the terminal 120 are configured with one or more logical connections moving traffic flows that carry user data (e.g., designated by T1 and T2). In the example shown, the host platform 110 may direct one or more separate logical traffic flows (e.g., shown at T4) for control of the radio/waveform being sent by the terminal 120. In other examples, the user data traffic and radio/waveform control flow may be carried using a single logical interface. The traffic flow T1 may be, for example, an incoming traffic flow, while the traffic flow T2 may be, for example, an outgoing traffic flow.

In some examples, a single physical interface between the host platform and the terminal may be configured to carry the user data traffic and the radio/waveform control information. Alternatively, multiple physical interfaces may be configured to separately carry the user data and the radio/waveform control information. In some examples, separate physical interfaces may be used to carry different user data traffic flows.

As is further shown in FIG. 5, the terminal 120 is configured with an audio interface, which may be used to receive audio input streams T6 from an operator or send an audio output to the operator of the terminal 120. The terminal 120 is also configured with a logical interface for transmitting IP data of the traffic flows T1/T2 over-the-air or receiving IP data over-the-air. The terminal 120 is configured with an over-the-air interface (also referred to herein as a radio or wireless interface), which may enable movement of application data flows T5 by the terminal via the MUOS group service.

The middleware 114 introduced in paragraphs above is described in greater detail herein. The middleware 114 may be a software (e.g., executed by a processor such as processor 111 shown of the host platform 110 of FIG. 3) providing various functionalities for observing data and characteristics of said data carried via the traffic flows between applications of the host platform 110 and the terminal 120. Alternatively, some (e.g., any one of, or all) of the functionality of middleware 114 may be implemented by way of one or more specialized circuits at the host platform 110. The middleware 114 may provide functionality for negotiating access by the terminal 120 to the over-the-air interface based on the observed data and characteristics of the observed data. The middleware 114 may provide functionality for negotiating access by the terminal 120 to the over-the-air interface based on radio conditions observed at the terminal's over-the air interface.

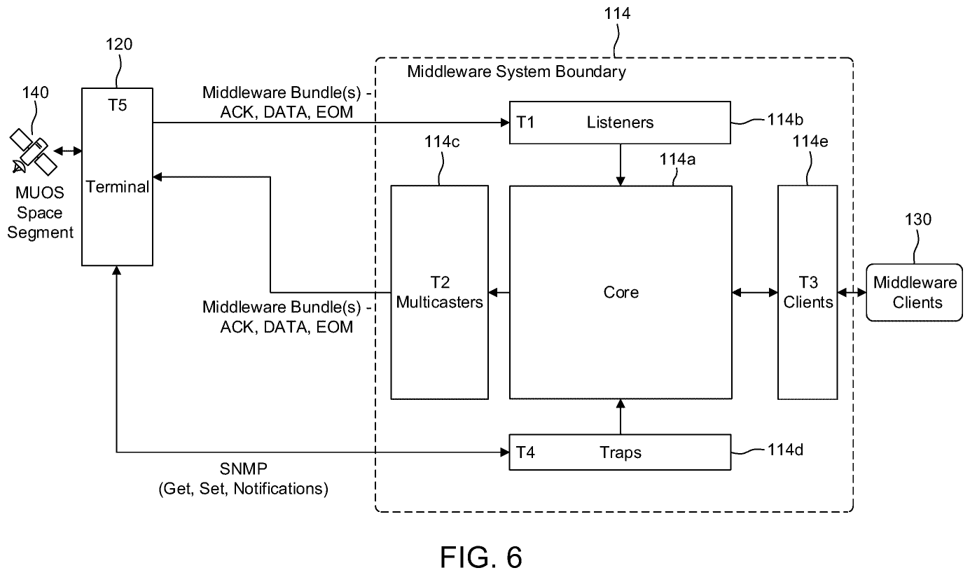

FIG. 6 is a software architecture diagram illustrating logical components of a middleware 114 operating on a host platform 110. The architecture shown in FIG. 6 illustrates multiple software modules, described in greater detail in paragraphs below, each of which may be logically implemented in one (or more) processes or circuits of the host platform 110 illustrated in FIG. 3.

As shown in FIG. 6, the software architecture includes a core module 114a, which processes data from other modules as described in further detail herein. The core module 114a may provide functionality for receiving and queueing incoming data traffic (i.e., shown in FIG. 6 by T1) from the terminal 120. For example, the core module 114a may logically interface with one or more listener modules 114b, which monitor for data received from a terminal 120 via a logical or physical interface with the terminal 120. The listener module 114b may include functionality for error correction or for decoding incoming data. Incoming data may include, for example, application data or control/management information necessary for efficient operation by multiple terminals in the MUOS network 100. For instance, the incoming data may include acknowledgement information (ACK) associated with transmissions previously sent by the terminal 120 or by other terminals. In some examples the incoming data may include information that signals the end of a message (EOM). The core module 114a may attempt to parse incoming application data.

The core module 114a may use information from the trap module 114d to make decisions on data queuing, transmissions, or other aspects relating to communication via the over-the-air interface. The trap module 114d monitors the state of the terminal 120 according to one or more methods described in paragraphs below. In some examples, the trap module 114d may employ a network management protocol, such as Simple Network Management Protocol (SNMP).

SNMP is an open-source application layer protocol that provides functionality for monitoring and management of network elements. The SNMP architecture includes a manager, an agent, and one or more managed objects. The manager (represented by way of example in FIG. 6 by the trap module 114d) may be implemented in a computer or processing device that executes SNMP network management software, which gathers and analyzes information from agents through message exchanges. The agent may, for example, be implemented in software running on a device within the network (represented by way of example in FIG. 6 by the terminal 120). A managed object may refer to a logical object that may correspond, for example, to a physical input or output, or to a radio channel that is being monitored.

SNMP messages are packet-based. Each packet may include, for example, a header, data, and checksum bytes. A packet may specify a message type or operation to be carried out (this is described in further detail in paragraphs below). SNMP devices utilize a Management Information Base (MIB), which acts as a codebook or dictionary for handling incoming messages correctly. A MIB is typically provided by a device manufacturer and provides definitions and info about the properties of managed resources and the services that the agents support. The MIB is organized in a tree structure with variables associated with unique object identifiers (OIDs), which correspond to the managed objects.

SNMP uses several key operations to manage and monitor network objects. Of particular note, SNMP uses the TRAP message (referred to interchangeably herein as a “trap,” or an “SNMP trap”) to inform an SNMP manager when an important event happens at the agent level. Agents may send system level notifications to the manager unilaterally when significant events occur. Traps may be asynchronous in nature, meaning they need only be sent when the agent has information to report. This may be beneficial when monitoring and managing alarms since traps may trigger instantaneously, rather than requiring a status request to be sent by the manager.

In some cases, the manager may also query an agent to ascertain the status of the managed network elements. For example, the GET message may be used by a manager to retrieve a value for a OID, while the GETNEXT message allows the manager to retrieve the next OID in the MIB tree, facilitating sequential data collection. GETBULK allows the manager to retrieve large data blocks, reducing the number of GETNEXT requests, and the SET operation modifies or sets the value of an object on a network device. The INFORM message is similar to the TRAP operation but requires the manager to send acknowledgment confirming receipt. The RESPONSE message is sent by an SNMP agent to reply to GET, SET, GETNEXT, GETBULK, or INFORM requests, providing requested data or operation status.

Although the description of examples provided herein may make specific reference to SNMP, it should be understood that other protocols for managing and monitoring network elements could be used interchangeably.

In the example shown in FIG. 6, the trap module 114d may monitor for alerts or system-level notifications as to the channel's status. When a certain predefined condition or event occurs, a SNMP enabled-device (e.g., an SNMP agent implemented in software running on the terminal 120) may send a trap to notify the trap module 114d (e.g., an SNMP manager implemented in software running on a host platform or other SNMP-enabled devices) without any prompting. A trap may indicate whether a voice or data transmission is ongoing on the channel. The trap module 114d sends or receives SNMP messages, including traps or messages specifying other SNMP operations, via a logical or physical interface with the terminal 120 as shown at T4.

The core module 114a may include functionality for sending data to the terminal 120 for transmission on the over-the-air interface. As shown in FIG. 6, the core module 114a may logically interface with a multicasting module 114c, which may be programmed to send outgoing data traffic (i.e., T2) to the terminal 120 via a logical or physical interface. Outgoing data traffic (i.e., shown as T5) is transmitted by the terminal 120 via the over-the-air interface. Outgoing data traffic may include, for example, application data or control/management information necessary for efficient operation by multiple terminals over the MUOS network 100. The core module 114a may also be configured to implement a set of rules for acknowledging received data, as described further in paragraphs below.

The structure of incoming and outgoing data traffic is described herein. Data traffic may be organized into payloads, each of which may include one or multiple packets containing multiple messages. Packets to be sent are queued and transmitted according to their message type. For example, packets may be sent once or regularly (i.e., at periodic intervals). A packet sent in each payload may include acknowledgement (ACK) information associated with transmissions previously sent by other terminals. In some examples, the first packet sent in each payload may include a header (i.e., a ‘MsgRcvdAck’ header packet) used to acknowledge successful receipt of a previously received message (e.g., the last message received). In some examples, the last packet sent for each payload includes a trailer (i.e., an End-of-Message (EOM) trailer), which may indicate the end of all traffic flows for a session.

The inclusion of the ACK, or the type of ACK information included, may be dependent upon whether data is successfully decoded. The ACK information may include, for example, a positive acknowledgement if a header and trailer are received no errors are detected. In some examples, ACK information may include a negative acknowledgement (NACK) indicating that a header and/or trailer were not received or not decoded, or that errors were detected. For instance, a NACK may be issued in the event a data transmission was received and an attempt was made to decode the data, but was unsuccessful.

In some examples the outgoing data may include information that signals an end-of-message (EOM), or the completion of an outgoing transmission.

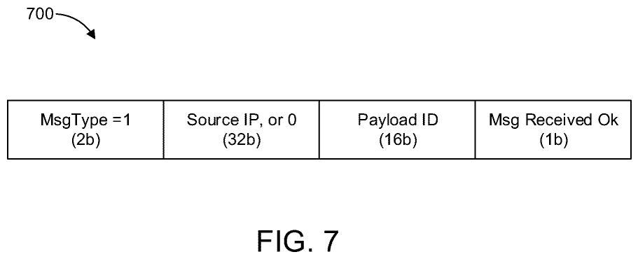

FIG. 7 is a diagram illustrating fields of a packet header as may be included in a payload. As shown in FIG. 7, the header packet 700 includes a MsgType field (2 bits), a Source IP address field (32 bits), a Payload ID field (16 bits), and a Msg Received ok field (1 bit). The MsgType field may be set to 1 (i.e., ‘01’) to indicate that the header packet is also a MsgRcvdAck message, which may indicate that the header is not only a header of new data, but that the header also acknowledges data that was received from a earlier transmission. By overloading messages, over-the-air access attempts may be minimized. The Source IP address field may indicate the IP address of the source of the last payload received. In some examples, the header 700 may include special acknowledgement information indicating no prior message was received. For instance, the Source IP address field may be set to 0 (i.e., ‘0.0.0.0’) if the sender has not received a prior message. The Payload ID field may include a sequence number of the last payload received from the source identified by the Source IP field.

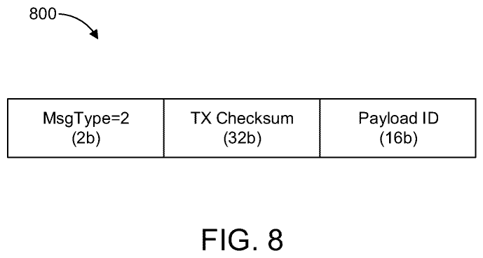

FIG. 8 is a diagram illustrating fields of a trailer as may be included in a payload. As shown in FIG. 8, the trailer 800 includes a MsgType field (2 bits), a TX checksum (32 bits), and a Payload ID field (16 bits). The MsgType field may be set to 2 (i.e., ‘10’) to signal the EOM message type. The TX checksum may provide a checksum or Forward Error Correction (FEC) code that allows for error correction or detection. The Payload ID field may provide a unique ID number or sequence number that corresponds to the payload received from this source.

Further describing the architecture of FIG. 6, the core module 114a may include functionality for detecting when an ongoing data transmission has been interrupted or overridden. In some examples, the core module 114a may detect that a data transmission is interrupted or overridden based on data received by the listener module 114b that indicates a negative ACK or a failure to receive any positive ACK responsive to the data transmission. For example, when a host platform sends a payload, the listener module 114b may listen for ACK information in a subsequent message (e.g., a next message) received from another host platform/terminal. When the listener module 114b receives data the indicates or suggests that a data transmission is interrupted or overridden, such as when the next message received does not acknowledge the sent transmission, the core module 114a may re-queue the data for transmission, preventing the data from being lost despite an unplanned interruption or error. Data that is to be retransmitted may be prioritized according to one or more methods described in further detail herein.

The core module 114a may include functionality for sending and/or receiving data to or from a client (e.g., an application). For example, the core module 114a may logically interface with clients 130 via a client module 114e, which may deliver IP application data to be queued and transmitted by the terminal 120 via over-the-air interface. By the same token, the core module 114a may attempt to parse data received via the listening module 114b and determine if the data is destined for a client 130. If so, it may route and deliver the data to the client via an API, shown in FIG. 6 by the traffic flow T3. The core module 114a may include functionality for brokering floor access for the over-the-air interface. For example, the core module 114a may, based on notifications issued regarding the group channel status, determine whether to send queued data to the terminal 120 for transmission via the channel.

The core module 114a may further include functionality for determining a priority associated with outgoing data. Data may be given or assigned one of three different priority levels. Each priority level may correspond to a backoff period, or a length of time that must elapse before channel access re-attempted. For example, for a medium priority level, if the channel cannot be access, the core module 114a may reattempt transmission after a medium period of time (e.g., applying a default backoff period). For a high priority data, if the channel cannot be accessed, the core module 114a may reattempt transmission after a relatively shorter period of time. For low priority data, a longer or less aggressive backoff period may be used. The priority determined for the outgoing data may depend upon whether a message carried in the data can be parsed or not. For instance, if a message cannot be parsed, the core module 114a may assign a default priority.

In addition, the priority determined for outgoing data may depend upon the content or nature of the message itself. For instance, a periodic broadcasting of position information may in some contexts be assigned a lower priority in comparison to a time-sensitive command and control messages issued to ground forces involved in a firefight. The core module 114a may be configured with a mapping between different types of messages and various priority levels.

Furthermore, the core module 114a may maintain multiple separate queues corresponding to the different priority levels. For instance, high priority data, medium priority data, and low priority data may each be stored in different queues. The core module 114a may negotiate access to the over-the-air interface to transmit queued data based on the priorities determined for the pending data. For example, the core module 114a may attempt to transmit data of the high priority queue more frequently that it does for data of the medium or low priority queues.

The core module 114a may include functionality for assessing and updating the priority of data present in a queue over time. For example, data may initially enter a low priority data queue or a medium priority data queue. Each data queue may operate in accordance with a first-in-first-out rule. The core module 114a may monitor how long data has been held within the queue. If the core module 114a determines that data has been present in a particular queue for an extended period of time (e.g., an amount of time that exceeds a threshold), the core module 114a may increase the priority of the data by moving the data e.g., from a low priority data queue to a medium priority data queue, or from the medium priority data queue to a high priority data queue. In other examples, the core module 114a may be configured to update the priority of data from a higher priority level to a lower priority level, or remove data from a queue entirely. For example, if retransmission has been attempted for data too many times (i.e., a number of times that exceeds a configured threshold), the core module 114a may determine to move the data to a lower priority queue or outright remove the data from the queue.

As described in further detail below, the middleware 114 may be configured to manage access to the network using the group service. The middleware 114 may do so by leveraging its functionality to assess the current network state and MUOS group floor status. To determine the group floor status, the trap module 114d may query terminal 120 in FIG. 6) regarding the group channel's status and/or may receive one or more of the following notifications (e.g., SNMP traps).

One type of notification may be a ‘GRANTED’ notification. In this instance, the notification may be issued when the terminal 120 has successfully accessed the channel.

One type of notification may be a ‘RELEASED’ notification. In this case, this notification may be issued when a transmitting terminal stops transmitting for a given amount of time (e.g., at least 1 second).

One type of notification may be a ‘TAKEN’ notification. In this case, the notification is sent to indicate a type of traffic (voice or data) being transmitted to the group. This notification may or may not include an indication of which user is transmitting.

One type of notification may be a ‘DENIED’ notification. This notification may be generated at a transmitter terminal to indicate that the transmitting terminal is not permitted to access the group channel. The notification may or may not include an indication of a possible reason why the transmitting terminal could not take the floor to transmit.

One type of notification may be a ‘Push-to-talk enabled’ notification. This notification may be generated at the local terminal when an operator squeezes the hand-mic on the radio to initiate a voice transmission.

The middleware 114 may queue data and receive notifications and/or query the radio for the current status of the floor via SNMP. If the radio's group floor is available, the core module 114a and the multicasting module 114c may send the queued data to the terminal 120 to transmit across the MUOS group. If the group floor is not available, the core module 114a may intelligently cache the data until the floor is available. The trap module 114d may again query the terminal 120 for the current status of the floor, applying an appropriate backoff period in accordance with a priority level of the queued data, substantially as described in paragraphs above.

Further describing the floor brokering functionality introduced above, the middleware 114 may leverage the floor broker to prevent any instance of the middleware 114 causing the terminal 120 to endlessly transmit, thereby hogging the group floor. The floor broker functionality may track source addresses of host platforms that send data in the MUOS group and may implement a round robin approach for each host platform to have a turn at grabbing the group floor. For instance, a transmitting middleware 114 instance may include its own IP address within ACK information. Receiving middleware instances may then receive the transmitting instance's IP address and maintain the IP address in a cache. Each middleware instance may sort the cache in descending order. In this way, all middleware instances may be aware of each other's status within the cache. By tracking the source addresses of nodes in a running cache of known senders and indexing itself in the order of the cache, the middleware 114 may determine an order of host platforms that are permitted to attempt to transmit, and may know when its next opportunity to transmit may occur. The host platforms that are permitted to transmit within the round robin approach may or may not be fixed. For example, new nodes may be added or removed from the cache, which may avoid the scenario where host platforms that have data queued for transmission needlessly sit idle while other host platforms, which may not have data queued for transmission, remain silent.

At a defined, configurable interval, the middleware senders' IP addresses may be evicted from the cache, which may reduce the presence of “stale” nodes that have not transmitted recently. In addition, a maximum transmission duration may be configured at each middleware instance. The enforcement of the maximum transmission duration and the maintenance of the cache may ensure each middleware instance is provided with an opportunity to transmit and may help avoid the scenario where one middleware instance hogs the floor.

The core module 114a may queue data based on (1) a network connectivity status, (2) based on whether a data call is active, and/or (3) based on a status of the group floor. For example, for the terminal 120 to establish and maintain connectivity with the network, the terminal may need to be registered with the network (e.g. with satellite and/or ground infrastructure) and within a coverage area of the network infrastructure. The network may authenticate the identity of the terminal and authorize the terminal for communication with the network.

For a data call to be active, a MUOS group service must be established with terminals managed by the ground segment. A group may be formed by using access control mechanisms that restrict unauthorized users from joining or listening to group transmissions. In order for a terminal 120 to broadcast data to other members of the group, the terminal 120 must be a member of the group service.

If the core module 114a determines the network is unavailable or the data call is down, it may queue all data while simultaneously attempting to restore the data call, assuming the network is still active. If the network is unavailable (e.g., the terminal is outside of a coverage area of the network), the core module 114a may queue data to be transmitted when connectivity is reestablished and the terminal has an active data call.

If the terminal 120 has network connectivity and has an active data call, the floor must still be clear before the terminal 120 can broadcast queued data to other member terminals of the group service. If the floor is not clear, the core module 114a may cache and prioritize data according to one or more methods described herein.

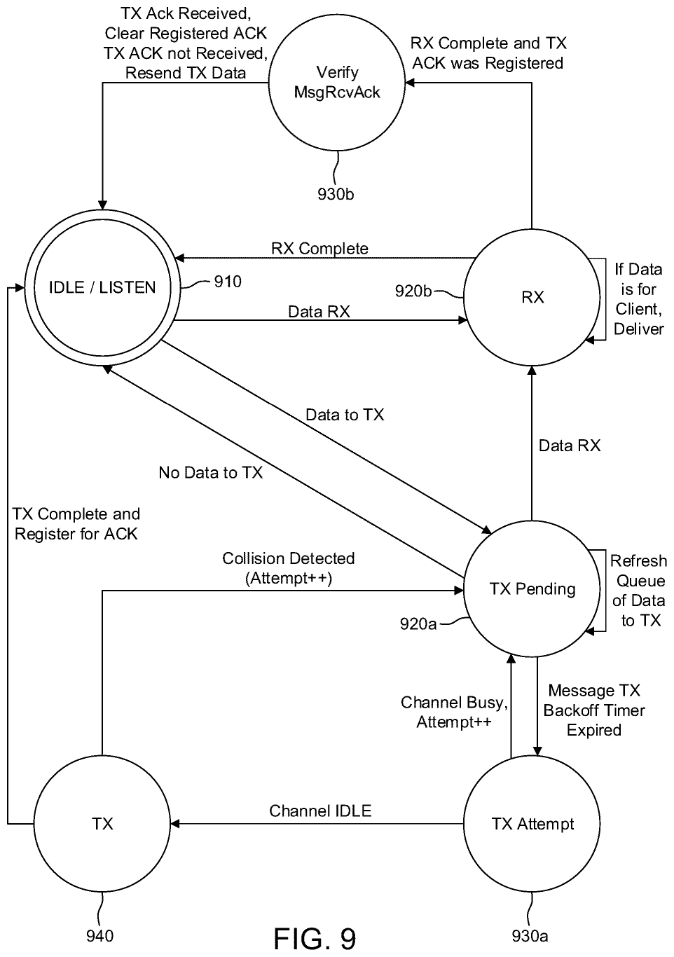

FIG. 9 is a state diagram illustrating various modes of operation of a middleware. As shown in FIG. 9, as shown at 910, the middleware may operate in an ‘IDLE/LISTEN’ state in which it monitors for incoming data, outgoing data, and notifications of the floor status. If the middleware 114 received outgoing data from a client to be queued and transmitted, the middleware 114 may move to a ‘TX Pending’ state, shown at 920a. If the outgoing data can be parsed and its priority can be verified, and if the outgoing data has a high priority, the middleware 114 may move to a ‘TX Attempt’ state, shown in FIG. 9 at 930a, and attempt to transmit the queued outgoing data as soon as the channel is available. Otherwise, for example, if the data is repetitive or low priority data, the middleware 114 may cache the data and queue the data for later transmission. In some examples, the middleware 114 may be configured with a parameter limiting the number of TX attempts that may be undertaken. A default number of TX attempts may be, for example, five attempts. In some examples, if the limit is reached or exceeded, the queued data may be dropped from the queue.

Over time, the queue may accumulate various different repetitive or low-priority data. The middleware 114 may periodically refresh its queue to prioritize data for which transmissions were previously attempted but blocked. The middleware 114 may separately prioritize queued high priority data from queued repetitive or low-priority data. The periodic refreshing of queue(s) may be carried out in accordance with a backoff period corresponding to the priority of each queue, substantially as described in paragraphs above.

If, upon attempting a transmission, the channel is idle and data is queued for transmission, the middleware may move to a ‘TX’ state as shown at 940 and move the queued data via its logical/physical interface to the terminal 120 for transmission over-the-air. The middleware 114 may then, in some examples, monitor for an ACK confirming that the transmitted data was successfully received. It may only be necessary that a single node transmit an ACK, as it may be assumed in such case that all nodes operating on the group channel should have received the transmitted data.

If, while operating in the ‘IDLE/LISTEN state’ shown at 910, the middleware 114 detects the reception of a data transmission, the middleware 114 may move to an ‘RX’ state, shown in FIG. 9 at 920b, and attempt to parse and examine the data to determine whether the data is for a client (e.g., an application). If successful, the middleware 114 may deliver the received data to a recipient address (e.g., for a specific client) or a destination address (e.g., a multicast address). Provided that the RX data can be parsed and delivered to the destination client, the middleware 114 may in some cases return to the IDLE/LISTEN state shown at 910. In some cases, the middleware may move to a ‘VerifyMsgRcvAck’ state, shown at 930b, and register for an ACK to confirm delivery of the data. In this state, the middleware 114 may determine whether at least one ACK has been issued confirming that the transmission of the data to the client was successful. If the ACK has been issued, the middleware 114 may clear the registered ACK. If no transmit ACK was received, the middleware 114 may determine to resend the transmitted data to the destination client.

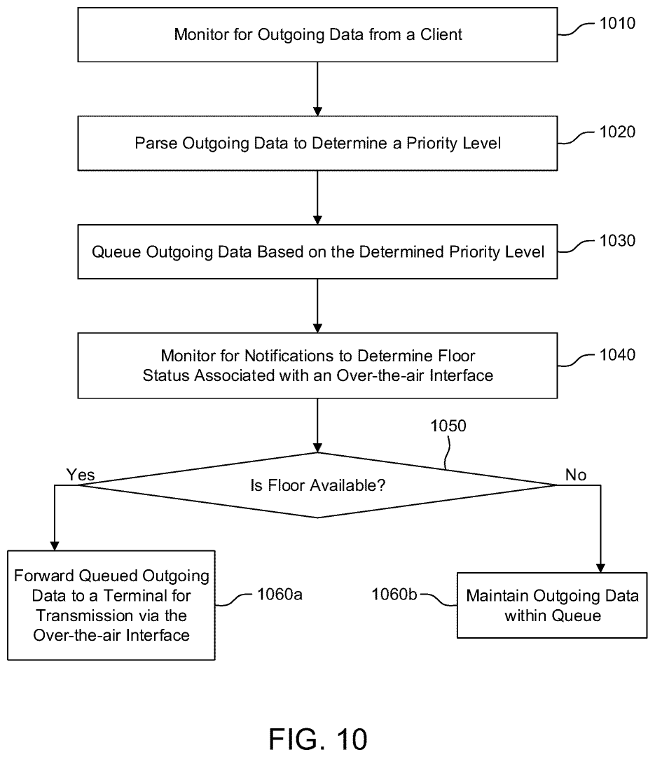

FIG. 10 is a flow chart illustrating an exemplary method as may be performed by a host platform operable in a MUOS network described herein. As shown in FIG. 10, at 1010, the host platform 110 monitors for outgoing data from a client, for example, by reading incoming data flows from one or more client applications. At 1020, the host platform 110 parses the outgoing data to determine a priority level associated with the outgoing data. At 1030, the host platform 110 queues the outgoing data based on the priority level. At 1040, the host platform 110 monitors for notifications (e.g., SNMP traps) to determine a floor status associated with an over-the-air interface provided by a terminal. At 1050, the host platform 110 determines whether the floor is available, for example, based on whether one or more SNMP traps are issued. For example, if an SNMP trap is issued that the floor status associated with the over-the air interface is “available” (i.e., in response to determining that the floor status is “available”), the host platform 110 forwards the queued outgoing data to a terminal for transmission via the over-the-air interface, shown at 1060a. In another example shown at 1060b, if an SNMP trap indicating the floor is available is not issued (i.e., in response to determining that an SNMP trap indicating that the floor status associated with the over-the-air interface is “available” has not been issued), the host platform 110 maintains the outgoing data within the queue for transmission at a subsequent time.

In some examples, if an SNMP trap is issued indicating that the floor status associated with the over-the-air interface is ‘taken’ (i.e., in response to determining that the floor status is “taken”), the host platform 110 maintains the outgoing data within the queue for transmission at a subsequent time and/or sends a signal to the terminal 120 to prevent the terminal from transmitting via the over-the-air interface.

In some examples, the outgoing data is maintained within the queue in accordance with a backoff period corresponding to the priority level associated with the outgoing data.

In some examples, the host platform 110 may monitor for incoming data received via the over-the-air interface, parse the incoming data, and issue an SNMP trap including an acknowledgment of the incoming data.

In some examples, the host platform 110 stores information indicating a plurality of nodes that have transmitted using the over-the-air interface.

In some examples, the forwarded outgoing data include a packet including a header indicating an acknowledgement of a previously-received payload.

In some examples, the header includes an indication of an internet protocol (IP) address associated with a sender of the previously-received message and an identifier associated with the previously-received payload.

In some examples the forwarded outgoing data comprises a packet includes a trailer including an end-of-message (EOM) indication.

In some examples, the host platform 110 stores at least one internet protocol (IP) addresses associated with another host platform in a cache, determines an order of other host platforms that are permitted to transmit, and determines, based on the order of other host platforms that are permitted to transmit, a next opportunity when the host platform may transmit.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method performed by a host platform operable in a Mobile User Objective System (MUOS) network, the method comprising:
monitoring for outgoing data from a client;
parsing the outgoing data to determine a priority level associated with the outgoing data;
queuing the outgoing data based on the priority level;
monitoring for Secure Network Management Protocol (SNMP) traps to determine a floor status associated with an over-the-air interface;
forwarding the queued outgoing data to a terminal for transmission via the over-the-air interface in response to determining the floor status is “available”; and
maintaining the outgoing data within the queue for transmission at a subsequent time in response to determining the floor status is “not available”.

2. The method of claim 1, comprising maintaining the outgoing data within the queue for transmission at a subsequent time in response to determining that an SNMP trap indicating that the floor status associated with the over-the air interface is ‘available’ is not issued.

3. The method of claim 1 comprising maintaining the outgoing data within the queue for transmission at a subsequent time and sending a signal to the terminal to prevent the terminal from transmitting via the over-the-air interface in response to determining that an SNMP trap is issued indicating that the floor status associated with the over-the-air interface is ‘taken’.

4. The method of claim 2, wherein the outgoing data maintained within the queue in accordance with a backoff period corresponding to the priority level associated with the outgoing data.

5. The method of claim 1, further comprising:
monitoring for incoming data received via the over-the-air interface;
parsing the incoming data; and
issuing an SNMP trap including an acknowledgment of the incoming data.

6. The method of claim 1, further comprising storing information indicating a plurality of nodes that have transmitted using the over-the-air interface.

7. The method of claim 1, wherein the forwarded outgoing data comprises a packet including a header indicating an acknowledgement of a previously-received payload.

8. The method of claim 7, wherein the header includes an indication of an internet protocol (IP) address associated with a sender of the previously-received payload and an identifier associated with the previously-received payload.

9. The method of claim 1, wherein the forwarded outgoing data comprises a packet including a trailer including an end-of-message (EOM) indication.

10. The method of claim 1 further comprising:
storing at least one internet protocol (IP) addresses associated with another host platform in a cache;
determining an order of other host platforms that are permitted to transmit; and
determining, based on the order of other host platforms that are permitted to transmit, a next opportunity when the host platform may transmit.

11. A host platform operable in a Mobile User Objective System (MUOS) network, the host platform comprising a processor and a memory configured to:
monitor for outgoing data from a client;
parse the outgoing data to determine a priority level associated with the outgoing data;
queue the outgoing data based on the priority level;
monitor for Secure Network Management Protocol (SNMP) traps to determine a floor status associated with an over-the-air interface; and
on a condition an SNMP trap is issued indicated that the floor status associated with the over-the air interface is “available”, forward the queued outgoing data to a terminal for transmission via an over-the-air interface.

12. The host platform of claim 11, wherein, on a condition an SNMP trap indicating that the floor status associated with the over-the air interface is ‘available’ is not issued, the processor and the memory are configured to maintain the outgoing data within the queue for transmission at a subsequent time.

13. The host platform of claim 11, wherein, on a condition an SNMP trap is issued indicating that the floor status associated with the over-the-air interface is ‘taken’, the processor and the memory are configured to maintain the outgoing data within the queue for transmission at a subsequent time and send a signal to the terminal to prevent the terminal from transmitting via the over-the-air interface.

14. The host platform of claim 12, wherein the outgoing data maintained within the queue in accordance with a backoff period corresponding to the priority level associated with the outgoing data.

15. The host platform of claim 11, the processor and the memory further configured to:
monitor for incoming data received via the over-the-air interface;
parse the incoming data; and
issue an SNMP trap including an acknowledgment of the incoming data.

16. The host platform of claim 11, the processor and the memory further configured to store information indicating a plurality of nodes that have transmitted using the over-the-air interface.

17. The host platform of claim 11, wherein the forwarded outgoing data comprises a packet including a header indicating an acknowledgement of a previously-received payload.

18. The host platform of claim 17, wherein the header includes an indication of an internet protocol (IP) address associated with a sender of the previously-received payload and an identifier associated with the previously-received payload.

19. The host platform of claim 11, wherein the forwarded outgoing data comprises a packet including a trailer including an end-of-message (EOM) indication.

20. The host platform of claim 11, the processor and the memory further configured to:
store at least one internet protocol (IP) addresses associated with another host platform in a cache;
determine an order of other host platforms that are permitted to transmit; and
determine, based on the order of other host platforms that are permitted to transmit, a next opportunity when the host platform may transmit.
